(19) United States
(12) Patent Application Publication
(10) Pub. No.: US 2025/0171307 A1
(43) Pub. Date: May 29, 2025

(54) METHOD OF PREPARING NITROGEN-DOPED CARBON NANOSHEETS

(71) Applicant: KING FAHD UNIVERSITY OF PETROLEUM AND MINERALS, Dhahran (SA)

(72) Inventors: Mohd Yusuf KHAN, Dhahran (SA); Aamir HANIF, Dhahran (SA); Md. Abdul AZIZ, Dhahran (SA)

(73) Assignee: KING FAHD UNIVERSITY OF PETROLEUM AND MINERALS, Dhahran (SA)

(21) Appl. No.: 18/518,726

(22) Filed: Nov. 24, 2023

(51) Int. Cl. C01B 32/15

(52) U.S. Cl. CPC C01B 32/15; C01P 2002/54; C01P 2002/72; C01P 2002/82; C01P 2002/85; C01P 2004/03; C01P 2006/12; C01P 2006/14; C01P 2006/16; C01P 2006/90

(57) ABSTRACT

A method of preparing nitrogen-doped carbon nanosheets comprises mixing dried and pulverized Albizia procera with an activation agent in a mass ratio from 1:1 to 1:5 to form a mixture and heating the mixture in an inert atmosphere at a temperature in the range of 400 to 800° C. for 2 to 8 hours to form the nitrogen-doped carbon nanosheets. The activation agent is a carbonate salt and the nitrogen-doped carbon nanosheets have an average pore diameter of 0.5 to 2.5 nm and a carbon dioxide adsorption capacity of 1.0 mmol/g to 3.50 mmol/g.

### STATEMENT REGARDING PRIOR DISCLOSURE BY THE INVENTORS

Aspects of the present disclosure were disclosed in Khan et al., “CO₂ Adsorption on Biomass-Derived Carbons from Albizia procera Leaves: Effects of Synthesis Strategies” published in Issue 5, Volume 39, ACS Omega, which is incorporated herein by reference in its entirety.

### STATEMENT OF ACKNOWLEDGEMENT

Support provided by the Interdisciplinary Research Center for Hydrogen and Energy Storage (IRC-HES), King Fahd University of Petroleum and Minerals, Saudi Arabia, through Project INHE2103 is gratefully acknowledged.

### BACKGROUND

### Technical Field

The present disclosure is directed towards nitrogen-doped carbon nanosheets, and particularly to nitrogen-doped carbon nanosheets prepared from biomass of Albizia procera leaves.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

Global warming is one of the most pressing issues of the 21st century, prompting international efforts to combat it. Owing to the disruption of the natural equilibrium of CO₂ between various sources and sinks on Earth, anthropogenic CO₂ emissions from fossil fuels are widely acknowledged as a large cause of an exponential rise in CO₂ levels in the atmosphere. Compared to a preindustrial revolution CO₂ level of about 280 ppm, the current CO₂ level is around 420 ppm. This level of CO₂ is causing severe effects on the climate, such as rising sea levels, retreating glaciers, and contributing to food scarcity. Effort must be taken to stop the rising trend of the accumulation of CO₂ in the atmosphere.

Using energy-efficient industrial technology and processes, switching to a renewable energy source, and sequestering CO₂ have been suggested as short- and long-term solutions to sequestering CO₂; however, it is not feasible to completely abandon the use of fossil fuels in the near future. Carbon capture and sequestration are a quicker and more efficient solution for achieving sustainability. Various methods, including chemical absorption, membrane separation, and solid adsorbent-based adsorption, have been investigated for CO₂ capture. The latter of these methods, whose efficacy depends on the composition of the adsorbent, is a safe and potentially economical choice. The adsorbents of choice are ones with high CO₂ adsorption capacity and selectivity, faster kinetics, facile regeneration, and the ability to be produced in large quantities at an economic scale.

To this extent, materials ranging from zeolites, molecular organic frameworks (MOFs), alkali and alkaline metal oxides-based materials, and functionalized silicas have been studied for CO₂ capture. Carbons generated from biomass have recently been highlighted as an economical and environmentally acceptable alternative to synthetic adsorbents. These carbons can be produced from easily accessible basic materials such as food, animal, and agricultural waste. While an original CO₂ adsorption capacity (less than 0.5 mmol/g at 298 K and 1 bar) of pyrolyzed biomass is relatively low, several modifications are known to enhance its capacity and selectivity toward CO₂. For example, doping of basic groups or heteroatoms, particularly nitrogen, is known to enhance the alkalinity and CO₂ adsorption capacity of the carbons.

Nitrogen doping of carbon material is a strategy used to enhance the CO₂ adsorption performance of carbon-based materials. Nitrogen serves as a basic group within the carbon networks, thereby enhancing interaction with the CO₂ molecule, which is acidic in nature. Conventionally, the nitrogen groups are introduced in carbon materials by two strategies via a post-treatment of the synthesized carbon material with additional basic nitrogen-rich chemical agents or gases, which then introduce surface nitrogen heteroatoms on the surface of the carbon material, and the heteroatom self-doping strategy, where a carbon precursor is made to react with a nitrogen precursor and then subjected to pyrolysis to form a uniform dispersion of nitrogen on the surface of the carbons. Using nitrogen-rich biomass precursors can achieve facile and more uniform doping of nitrogen heteroatoms; however, these strategies rely on synthetic precursors and a multistep synthesis scheme which adds to the complexity of the process and makes it economically unattractive.

Enhancement of micropore density is a second strategy used to increase the CO₂ adsorption performance of carbon-based materials. Micropores with a size of <1 nm typically provide a strong interaction with the CO₂ molecules due to the small size close to that of the kinetic diameter of CO₂, which enables better interaction through overlapping adsorption forces and potential fields from nearby pore walls. Further, for the introduction of micropores, a post-synthesis treatment with steam or CO₂ is generally followed. The carbons obtained by the pyrolysis of biomass are exposed to CO₂ or steam at a high temperature (500-900° C.). Dissociative chemisorption of CO₂ occurs on the carbon, leading to surface oxides and CO, which are subsequently released from the surface, aiding in the formation of micropores. In the steam modification, the reactive centers dissociate water molecules, forming a bond with oxygen and releasing H₂, which forms transient hydrogen complexes on the surface. These surface complexes are finally released, leaving the carbon in a highly porous state.

A post-synthesis activation method for carbons obtained from biomass to achieve a high level of microporosity entails enhancing micropore formation and boosting CO₂ adsorption capabilities by utilizing CO₂ or steam as activating agents at temperatures between 500 and 900° C. [Igalavithana et al., Science of the total environment, 739, 139845, 2020, incorporated herein by reference in its entirety]; however, because carbon formation and activation is a two-step process, this method frequently requires a lot of time and energy. Additionally, temperature, flow rate, and even synthesis equipment used can affect the final porosity.

The steam and CO₂ post-synthesis activation strategies, however, suffer from the need for a two-step preparation process, a continuous supply of high-purity CO₂ and steam at high temperatures for several hours, and non-uniform exposure of the material to the activating gas, leading to decreased efficiency and questionable reproducibility of the activation process.

Despite numerous advances in the field, there still exists a need to develop a method that overcomes the limitations of the art. Accordingly, an object of the present disclosure is to develop an efficient method to prepare a highly selective carbon material from biomass for capturing CO₂ to overcome the limitations of the art.

### SUMMARY

In an exemplary embodiment, a method of preparing nitrogen-doped carbon nanosheets is described. The method comprises mixing dried and pulverized Albizia procera with an activation agent in a mass ratio from 1:1 to 1:5 to form a mixture and heating the mixture in an inert atmosphere at a temperature in the range of 400 to 800° C. for 2 to 8 hours to form the nitrogen-doped carbon nanosheets. The activation agent is a carbonate salt. The nitrogen-doped carbon nanosheets have an average pore diameter of 0.5 to 2.5 nm and a carbon dioxide adsorption capacity of 1.0 mmol/g to 3.50 mmol/g.

In some embodiments, the mass ratio of Albizia procera to activation agent is 1:2, the heating temperature is 700° C., the heating time is 5 hours, and the nitrogen-doped carbon nanosheets have an average pore diameter of 1.2 to 1.5 nm.

In some embodiments, the nitrogen-doped carbon nanosheets have a porous foam shape comprising interconnected networks of perforated nanosheets.

In some embodiments, the nitrogen-doped carbon nanosheets comprise nitrogen in an amount from 15 to 30% by weight based on a total weight of the nitrogen-doped carbon nanosheets.

In some embodiments, the nitrogen-doped carbon nanosheets comprise carbon in an amount from 65 to 70% by weight and oxygen in an amount from 5 to 20% by weight based on the total weight of the nitrogen-doped carbon nanosheets.

In some embodiments, the nitrogen-doped carbon nanosheets have a Brunauer-Emmett-Teller surface area of 25 to 450 m2/g.

In some embodiments, the mass ratio of Albizia procera to activation agent is 1:2, the heating temperature is 700° C., the heating time is 5 hours, and the nitrogen-doped carbon nanosheets have a Brunauer-Emmett-Teller surface area of 410 to 440 m²/g.

In some embodiments, the nitrogen-doped carbon nanosheets have a total pore volume of 0.030 to 0.300 cm³/g.

In some embodiments, the mass ratio of Albizia procera to activation agent is 1:2, the heating temperature is 700° C., the heating time is 5 hours, and the nitrogen-doped carbon nanosheets have a total pore volume of 0.150 to 0.200 cm³/g.

In some embodiments, the nitrogen-doped carbon nanosheets have a Horvath-Kawazoe micropore volume of 0.010 to 0.200 cm³/g.

In some embodiments, 40 to 70% of pores in the nitrogen-doped carbon nanosheets are micropores based on the total pore volume.

In some embodiments, the mass ratio of Albizia procera to activation agent is 1:2, the heating temperature is 700° C., the heating time is 5 hours, and the nitrogen-doped carbon nanosheets have a carbon dioxide adsorption capacity of 2.4 to 2.8 mol/kg at a temperature of 0° C. and at a pressure of 1 bar.

In some embodiments, the nitrogen-doped carbon nanosheets have a nitrogen adsorption capacity of 0.01 to 0.20 mol/kg at a temperature in the range of 0 to 25° C. and at a pressure of 1 bar.

In some embodiments, the nitrogen-doped carbon nanosheets have a carbon dioxide working capacity of 0.5 to 2 mmol/g.

In some embodiments, the mass ratio of Albizia procera to activation agent is 1:2, the heating temperature is 700° C., the heating time is 5 hours, and the nitrogen-doped carbon nanosheets have a carbon dioxide working capacity of 1.3 to 1.7 mol/kg at a temperature of 0° C. and at a pressure of 1 bar.

In some embodiments, the mass ratio of Albizia procera to activation agent is 1:2, the heating temperature is 600° C., the heating time is 5 hours, and the nitrogen-doped carbon nanosheets have a selectivity of 47 to 52 based on a fraction of carbon dioxide adsorption capacity over nitrogen adsorption capacity multiplied by a fraction of nitrogen partial pressure over carbon dioxide partial pressure at a temperature of 0° C.

In some embodiments, the mass ratio of Albizia procera to activation agent is 1:2, the heating temperature is 700° C., the heating time is 5 hours, and the nitrogen-doped carbon nanosheets have a selectivity of 28 to 33 based on the fraction of carbon dioxide adsorption capacity over nitrogen adsorption capacity multiplied by the fraction of nitrogen partial pressure over carbon dioxide partial pressure at a temperature of 25° C.

In some embodiments, the mass ratio of Albizia procera to activation agent is 1:2, the heating temperature is 500° C., the heating time is 5 hours, and the nitrogen-doped carbon nanosheets have a regenerability of 59 to 63% based on the carbon dioxide working capacity and carbon dioxide adsorption capacity at a temperature of 0° C.

In some embodiments, the mass ratio of Albizia procera to activation agent is 1:2, the heating temperature is 600° C., the heating time is 5 hours, and the nitrogen-doped carbon nanosheets have a regenerability of 67 to 72% based on the carbon dioxide working capacity and carbon dioxide adsorption capacity at a temperature of 25° C.

In some embodiments, the carbonate salt is sodium bicarbonate.

These and other aspects of the non-limiting embodiments of the present disclosure will become apparent to those skilled in the art upon review of the following description of specific non-limiting embodiments of the disclosure in conjunction with the accompanying drawings. The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure (including alternatives and/or variations thereof) and many of the attendant advantages thereof will be readily obtained as the same becomes better understood by reference to the following detailed description when considered in connection with the accompanying drawings, wherein:

FIG. 1 is a flowchart depicting a method of preparing nitrogen-doped carbon nanosheets (NDCs), according to certain embodiments;

FIG. 2 illustrates X-ray diffraction (XRD) patterns of the NDCs prepared at various pyrolysis temperatures (NDC-500, NDC-600, and NDC-700), according to certain embodiments;

FIG. 3 illustrates Raman spectra of the NDCs prepared at various pyrolysis temperatures (NDC-500, NDC-600, and NDC-700), according to certain embodiments;

FIG. 4 illustrates Fourier-transform infrared (FTIR) spectra of the NDCs prepared at various pyrolysis temperatures (NDC-500, NDC-600, and NDC-700), according to certain embodiments;

FIG. 5A illustrates a field emission scanning electron microscopy (FESEM) micrograph of NDC-500, according to certain embodiments;

FIG. 5B illustrates an FESEM micrograph of the NDC-600, according to certain embodiments;

FIG. 5C illustrates an FESEM micrograph of the NDC-700, according to certain embodiments;

FIG. 6A illustrates energy-dispersive X-ray (EDX) spectra of the NDC-500, according to certain embodiments;

FIG. 6B illustrates EDX spectra of the NDC-600, according to certain embodiments;

FIG. 6C illustrates EDX spectra of the NDC-700, according to certain embodiments;

FIG. 7 illustrates a plot of the N₂ adsorption of the NDCs prepared at various pyrolysis temperatures (NDC-500, NDC-600, and NDC-700), according to certain embodiments;

FIG. 8 illustrates a plot of the density functional theory (DFT) pore size distribution of the NDCs prepared at various pyrolysis temperatures (NDC-500, NDC-600, and NDC-700), according to certain embodiments;

FIG. 9 illustrates a plot of the Langmuir and dual-site Langmuir fitting of the NDC-500 isotherm at 0° C., according to certain embodiments;

FIG. 10 illustrates carbon dioxide and nitrogen adsorption isotherms of the NDCs at 0° C., according to certain embodiments;

FIG. 11 illustrates carbon dioxide and nitrogen adsorption isotherms of the NDCs at 25° C., according to certain embodiments; and

FIG. 12 illustrates a plot of CO₂/N₂ adsorption selectivity of the NDCs at various temperatures and pressures, according to certain embodiments.

### DETAILED DESCRIPTION

In the following description, it is understood that other embodiments may be utilized, and structural and operational changes may be made without departure from the scope of the present embodiments disclosed herein.

When describing the present disclosure, the terms used are to be construed in accordance with the following definitions, unless a context dictates otherwise. Embodiments of the present disclosure will now be described more fully hereinafter with reference to the accompanying drawings wherever applicable in which some, but not all, embodiments of the disclosure are shown.

Reference will now be made to specific embodiments or features, examples of which are illustrated in the accompanying drawings. In the drawings, whenever possible, corresponding or similar reference numerals will be used to designate identical or corresponding parts throughout the several views. Moreover, references to various elements described herein are made collectively or individually when there may be more than one element of the same type; however, such references are merely exemplary in nature. It may be noted that any reference to elements in the singular may also be constructed to relate to the plural and vice-versa without limiting the scope of the disclosure to the exact number or type of such elements unless set forth explicitly in the appended claims. Further, as used herein, the use of singular includes plural and the words “a,” “an,” and the like generally carry a meaning of “one or more,” and “at least one,” unless stated otherwise.

Furthermore, the terms “approximately,” “approximate,” “about,” and similar terms generally refer to ranges that include the identified value within a margin of 20%, 10%, or preferably 5%, and any values there between.

The use of the terms “include,” “includes,” “including,” “have,” “has,” or “having” should be generally understood as open-ended and non-limiting unless specifically stated otherwise.

As used herein, the term “precursor material” refers to any carbon-based or carbon-containing material that can become transformed into a solid porous carbon mass upon pyrolysis and/or carbonization. A precursor is any compound that participates in a chemical reaction that produces another compound.

As used herein, the term “pyrolysis” refers to the thermal decomposition of precursor material at elevated temperatures under inert conditions in which the precursor material is converted substantially to a carbon solid. Pyrolysis is often used to convert an organic material, such as biomass, to a carbon mass.

As used herein, the term “activation” refers to the treatment of precursor material with certain chemicals during or before pyrolysis.

As used herein, the term “activation agent” refers to a chemical used to treat precursor material during pyrolysis. An activation agent may be used to increase a desired chemical or physical property of the precursor material.

As used herein, the term “nitrogen-doped” in the term “nitrogen-doped carbon nanosheets” refers to that for any given carbon nanosheets, at least a portion of the carbon sites in the graphitic structure of the carbon nanosheets are filled with nitrogen atoms instead of with carbon atoms, such that the portion of carbon sites so filled with nitrogen would be detectable by common analytical means known in the art such as X-ray photoelectric spectroscopy, for example. Nitrogen-doping may be used to improve physical and chemical properties of the carbon nanosheets.

As used herein, the term “carbon nanosheets” refers to a two-dimensional carbon nanostructure with thicknesses of 2 nanometers or less. The thickness of the carbon nanosheets may vary from a single graphene layer to two, three, four, or more layers.

As used herein, the term “pulverize” refers to pounding, crushing, cutting, grinding, beating or otherwise reduce a larger particle-size substance into a small particle-size substance.

As used herein, the term “nitrogen-doped carbon nanosheets (NDCs)” may also be referred to as “carbon nanosheets” or “sample” for the sake of brevity.

Aspects of the present disclosure are directed to the usage of high-performance CO₂ adsorbents made from biomass-derived carbon obtained from Albizia procera leaves. Leaves were washed, dried, pulverized, and then pyrolyzed at three different temperatures of 500, 600, and 700° C. using NaHCO₃ as an activator. N₂ adsorption analysis at 77 K revealed that the pyrolysis temperatures have a bearing on the porosity and surface area. Raman spectroscopy revealed that higher pyrolysis temperatures lead to a more aromatic nature of the resultant carbons in the carbon nanosheets. The carbon nanosheets comprises nitrogen in an amount of 18 to 25 percent by weight of the total weight of the carbon nanosheets. These subtle physicochemical and morphological differences have an effect on the CO₂ adsorption characteristics of the adsorbents. The carbon nanosheets have a CO₂ adsorption capacity of up to 2.5 mmol/g. The carbon nanosheets have a selectivity for CO₂ of up to 54 times over a selectivity for N₂.

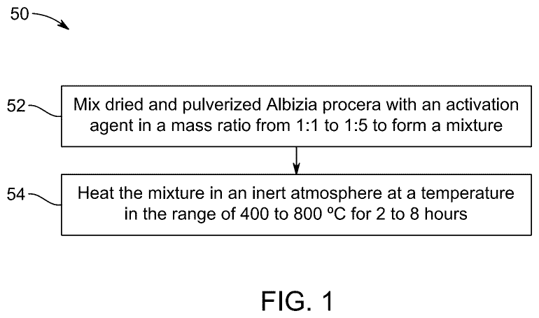

FIG. 1 illustrates a flow chart of a method 50 of preparing nitrogen-doped carbon nanosheets. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

The present disclosure is directed to methods of preparing nitrogen-doped carbon nanosheets (NDCs) from the biomass of Albizia procera. Albizia procera, commonly known as white siris or karoi tree, is a species of a large tree found natively in southeast Asia and India. Various parts of A. procera, such as the trunk, the stems, the roots, the leaves (or frond or leaflet), the inflorescence, the fruit, the pulp, the offshoot, and the like, may be processed for different materials and for different purposes.

At step 52, method 50 includes mixing dried and pulverized Albizia procera with an activation agent to form a mixture. Different plant material parts of the Albizia procera, such as leaves, branches, wood, flowers, fruits, seeds, husks, strew, roots, and the like, may be used to prepare the NDCs. In a preferred embodiment, the plant material is leaves. The leaves of Albizia procera are used as a starting material to prepare the NDCs due to their inherent high percentage of nitrogen. Although the description refers to the use of the Albizia procera, it may be understood by a person skilled in the art that any species of the genus Albizia may be used for the preparation of NDCs.

The dried and pulverized Albizia procera plant material may be obtained by cutting the Albizia procera leaves and drying in the sun and/or at a temperature of 90 to 140° C. For this purpose, fresh Albizia procera leaves may be collected or otherwise obtained and cut/chopped into small pieces, and optionally rinsed and/or cleaned with water before being dried in the sun. The water may be tap water, distilled water, double distilled water, deionized water, water purified by reverse osmosis, and the like. The Albizia procera leaves are shredded to a size of about 1 to 5 cm, preferably about 2 to 4 cm, and yet more preferably about 2 to 3 cm. The Albizia procera leaves may be shredded manually or by using a shredder, blender, mixer, grinder, and the like. The cut Albizia procera leaves may then be dried further, for example, in an oven at 90 to 140° C., preferably 95 to 130° C., preferably 100 to 120° C., preferably about 100 to 110° C., to reduce the moisture content to below about 5 wt. %, preferably below 4 wt. %, preferably below 3 wt. %, more preferably below 2 wt. %, and yet more preferably below about 1 wt. %. The cut Albizia procera leaves may be dried for any amount of time that provides an adequately dried product, typically, for drying times of 24 to 72 hours, preferably 30 to 60 hours, and more preferably about 48 hours.

The dried Albizia procera leaves are further pulverized using any suitable means, for example, by grinding, ball milling, blending, and the like, using manual methods (e.g., mortar), machine-assisted methods such as using a mechanical blender, or any other apparatus known to those of ordinary skill in the art. The dried Albizia procera leaves are preferably pulverized until an average particle size of less than 100 μm is achieved. In an embodiment, the Albizia procera leaves are pulverized for 1 to 30 minutes, preferably 2 to 20 minutes, preferably 3 to 10 minutes, more preferably 4 to 7 minutes, and yet more preferably about 5 minutes. The Albizia procera leaves are sieved through a mesh with a size of 150 to 500 μm, preferably 60 to 400 μm, preferably 70 to 300 μm, preferably 80 to 200 μm, more preferably 90 to 120 μm, and yet more preferably about 100 μm. In preferred embodiments, the dried Albizia procera leaves are then mixed in the presence of the activation agent. The activation agent is a carbonate salt, including, but not limited to, sodium carbonate, sodium bicarbonate, potassium carbonate, potassium bicarbonate, cesium bicarbonate, magnesium bicarbonate, calcium bicarbonate, the like, and a combination thereof. In a preferred embodiment, the activation agent is sodium bicarbonate. In an embodiment, the mixing of the Albizia procera leaves with the activation agent is for 1 to 30 minutes, preferably 2 to 20 minutes, preferably 3 to 10 minutes, more preferably 4 to 7 minutes, and yet more preferably about 5 minutes to form the mixture that is homogeneous in nature. In some embodiments, the weight ratio of dried Albizia procera leaves to activation agent ranges from 1:1 to 1:5, preferably 1:2 to 1:4, preferably 1:2.

At step 54, method 50 includes heating the mixture in an inert atmosphere at a temperature in the range of 400 to 800° C. for 2 to 8 hours to form the nitrogen-doped carbon nanosheets. In an embodiment, the heating is carried out in an inert atmosphere at about 400 to 800° C., preferably 450 to 750° C., preferably 500 to 700° C., preferably about 500° C., preferably about 600° C., and preferably about 700° C. This process is called pyrolysis. Pyrolysis is a process of thermochemical decomposition of the Albizia procera leaves at elevated temperatures and in the absence of an oxidizing agent such as oxygen, hydrogen peroxide, and/or a halogen-containing gas (e.g., a chlorine-containing gas). In some embodiments, pyrolysis is performed in an inert gas (e.g., nitrogen, helium, neon, and/or argon), preferably nitrogen, and in a temperature range of 400 to 800° C., preferably 425 to 775° C., preferably 450 to 750° C., preferably 500 to 700° C., preferably about 500° C., preferably about 600° C., or preferably about 700° C.

In some embodiments, pyrolysis may be performed by placing the mixture into a furnace such as a tube furnace, for example, in a ceramic crucible (e.g., an alumina crucible) or other forms of containment, and heating to the temperatures described above. The furnace is preferably equipped with a temperature control system, which may provide a heating rate of up to 50° C./min, preferably up to 40° C./min, preferably up to 30° C./min, preferably up to 20° C./min, preferably up to 10° C./min. In preferred embodiments, the mixture is heated with a heating rate in the range of 1 to 20° C./min, preferably 3 to 15° C./min, preferably 5 to 12° C./min, and more preferably about 10° C./min to an elevated temperature described above. The mixture is heated at such an elevated temperature (e.g., 500-700° C.) for 1 to 15 hours, preferably 2 to 10 hours, preferably 3 to 8 hours, preferably 4 to 6 hours, and more preferably about 5 hours. The furnace may also be equipped with a cooling accessory such as a cooling air stream system, or a liquid nitrogen stream system, which may provide a cooling rate of up to 20° C./min, preferably up to 15° C./min, preferably up to 10° C./min, preferably up to 5° C./min. In preferred embodiments, the mixture is cooled at a ramp down cooling rate in the range of 1 to 15° C./min, preferably 3 to 10° C./min, preferably 4 to 7° C./min, and more preferably about 5° C./min to a temperature in a range of 20 to 80° C., preferably 30 to 70° C., more preferably 40 to 60° C., and yet more preferably about 50° C. Pyrolysis of the pulverized Albizia procera leaves preferably forms a solid, for example, a carbonaceous ash, char, tar, and the like that mainly contains NDCs. The pyrolysis of the pulverized Albizia procera leaves may also form volatile compounds, which may evaporate during the pyrolysis.

The pyrolyzed Albizia procera leaves may be treated with an acid solution. The acid solution may comprise hydrochloric acid, hydrobromic acid, hydroiodic acid, sulfuric acid, nitric acid, phosphoric acid, the like, and a combination there of. In a preferred embodiment, the acid solution comprises hydrochloric acid. The acid solution may have a concentration of 0.1 to 10 M, preferably 0.5 to 5 M, preferably 1 to 2 M, and more preferably about 1 M. The pyrolyzed Albizia procera leaves may be treated with the acid solution using any known agitation method known to those of ordinary skill in the art, for example, via stirring, swirling, mixing, sonicating (e.g., ultrasonication or sonication). Treatment times may range from 10 to 60 minutes, preferably 15 to 30 minutes, and more preferably 20 minutes. The treated Albizia procera leaves may be washed with water for 1 to 5 times, preferably 2 to 4 times, and preferably about 3 times, and further dried at 50 to 80° C., preferably 55 to 75° C., preferably 60 to 70° C., and more preferably about 60° C., for 12 to 48 hours, preferably 20 to 30 hours, preferably 24 to 26 hours, and more preferably about 24 hours to form the NDCs.

Energy-dispersive spectroscopy (EDS) spectra of the NDCs show nitrogen in an amount from about 15 to 35%, more preferably 15 to 30%, and yet more preferably about 18 to 25% by weight based on the total weight of the NDCs, carbon in an amount from about 65 to 70%, preferably 66%, preferably 67 to 68% by weight based on the total weight of the NDCs, and oxygen in an amount from about 5 to 20%, preferably 8 to 14% by weight based on the total weight of the NDCs.

The NDCs prepared by the method of present disclosure have an average pore diameter of 0.5 to 3.0 nm, preferably about 0.6 to 2.8 nm, preferably about 0.7 to 2.6 nm, preferably about 0.8 to 2.5 nm, preferably about 0.9 to 2.4 nm, and preferably about 1.0 to 2.3 nm. In a preferred embodiment, the NDCs have an average pore diameter of about 1.5 to 2.2 nm.

The NDCs have a porous foam shape, including interconnected networks of perforated nanosheets with ridges and spikes. In some embodiments, the porous foam shape of the NDCs may comprise cavities or holes with a diameter of 0.05 to 5 μm, preferably 0.1 to 3 μm, preferably 0.2 to 2 μm, preferably 0.5 to 1 μm, or preferably 0.7 to 0.9 μm. The NDCs have a Brunauer-Emmett-Teller surface area of about 25 to 450 m²/g, preferably 38 to 430 m²/g, preferably 50 to 430 m²/g, preferably 110 to 430 m²/g, preferably 115 to 427 m²/g. The NDCs have a total pore volume of about 0.030 to 0.300 cm³/g, preferably 0.040 to 0.280 cm³/g, preferably 0.050 to 0.250 cm³/g, preferably 0.060 to 0.240 cm³/g. The NDCs have a Horvath-Kawazoe micropore volume of about 0.010 to 0.200 cm³/g, preferably 0.020 to 0.180 cm³/g, preferably 0.030 to 0.160 cm³/g, preferably 0.040 to 0.140 cm³/g. The NDCs show a narrow H3 hysteresis loop, which indicates the occurrence of mesopores and micropores (microporosity and mesoporosity), with a predominance of microporosity as well as some mesoporosity. In an embodiment, about 40 to 80%, preferably 50 to 80%, preferably 60 to 70% of pores in the NDCs are micropores based on the total pore volume.

The NDCs have a carbon dioxide adsorption capacity of about 1.0 mmol/g to 3.50 mmol/g, preferably 1.2 mmol/g to 3.3 mmol/g, preferably 1.5 to 3.0 mmol/g, preferably 1.7 mmol/g to 2.8 mmol/g. More specifically, the NDCs have a carbon dioxide adsorption capacity of about 1.0 to 3.0 mol/kg, preferably 1.1 to 2.9 mol/kg, preferably 1.2 to 2.8 mol/kg, preferably 1.3 to 2.7 mol/kg, or preferably 1.4 to 2.6 mol/kg at a temperature of about 0° C. and at a pressure of about 1 bar. The NDCs have a carbon dioxide adsorption capacity of about 0.6 to 2.2 mol/kg, preferably 0.7 to 2.1 mol/kg, preferably 0.8 to 2.0 mol/kg, preferably 0.9 to 1.9 mol/kg, or preferably 1.0 to 1.8 mol/kg at a temperature of about 25° C. and at a pressure of about 1 bar. The NDCs demonstrated a nitrogen adsorption capacity of about 0.01 to 0.20 mol/kg, preferably 0.03 to 0.18 mol/kg, preferably 0.05 to 0.16 mol/kg, or preferably 0.07 to 0.14 mol/kg at a temperature of about 0° C. and 25° C. at a pressure of about 1 bar. The NDCs have a carbon dioxide working capacity of about 0.5 to 2 mmol/g, preferably 0.6 to 1.9 mmol/g, preferably 0.7 to 1.8 mmol/g, preferably 0.8 to 1.7 mmol/g, preferably 0.9 to 1.6 mmol/g, or preferably 1.0 to 1.5 mmol/g at a temperature of about 0° C., and a carbon dioxide working capacity of about 0.4 to 1.5 mmol/g, preferably 0.5 to 1.4 mmol/g, preferably 0.6 to 1.3 mmol/g, or preferably 0.7 to 1.2 mmol/g at a temperature of about 25° C.

The NDCs have a selectivity of about 30 to 55, preferably 33 to 52, preferably 35 to 50, or preferably 37 to 47 based on a fraction of carbon dioxide adsorption capacity over nitrogen adsorption capacity multiplied by a fraction of nitrogen partial pressure over carbon dioxide partial pressure at a temperature of about 0° C., and a selectivity of 15 to 35, preferably 17 to 32, preferably 20 to 30 or preferably 22 to 28 based on the fraction of carbon dioxide adsorption capacity over nitrogen adsorption capacity multiplied by the fraction of nitrogen partial pressure over carbon dioxide partial pressure at a temperature of 25° C.

In an embodiment, the NDCs have a regenerability of about 45 to 80%, preferably about 50 to 75%, preferably about 55 to 70% based on the carbon dioxide working capacity and carbon dioxide adsorption capacity at a temperature of about 0° C. In an embodiment, the NDCs have a regenerability of about 50 to 85%, preferably about 55 to 80%, preferably about 60 to 75% based on the carbon dioxide working capacity and carbon dioxide adsorption capacity at a temperature of about 25° C.

### EXAMPLES

The following examples demonstrate a method of preparing nitrogen-doped carbon nanosheets. The examples are provided solely for illustration and are not to be construed as limitations of the present disclosure, as many variations thereof are possible without departing from the spirit and scope of the present disclosure.

### Example 1: Preparation of Nitrogen-Doped Carbon Nanosheets

Leaves of Albizia procera were collected from the university compound of King Fahad University of Petroleum and Minerals, Dhahran-Saudi Arabia. The Albizia procera leaves were then washed with deionized water, followed by drying in the sun for two days until the leaves developed a crispy texture. The leaves were then further dried under controlled conditions in a forced air convection oven at 100° C. for about two days. The dried leaves were then pulverized to fine powder with a kitchen blender and sieved through a mesh of 100 μm size. Approximately 3 g of the obtained fine powder was mixed with about 6 g of NaHCO₃ (99.7%, Sigma Aldrich) and homogenized in a blender for about 5 minutes. The homogenized mixture was then subjected to different pyrolysis temperatures of 500, 600, and 700° C. under flowing nitrogen (N₂) (99.99% purity, SCG Gas, Saudi Arabia) for about 5 hours. Final pyrolysis temperatures were attained at a rate of 10° C./min and, after completion of dwell time, cooled down in a controlled manner with a ramp-down rate of 5° C./min under flowing nitrogen. Once the temperature reached below about 50° C., the pyrolyzed materials were removed and washed with 100 mL of 1 M HCl in an ultrasonic bath for 20 minutes. The washed pyrolyzed materials were recovered by centrifugation and washed three times with deionized water over a filter paper. Finally, the washed pyrolyzed materials were dried at 60° C. in an oven for 24 hours to obtain the nitrogen-doped carbon nanosheets. The nitrogen-doped carbon nanosheets were coded as NDC-500, NDC-600, and NDC-700, where the numbers 500, 600, and 700 indicate the temperature at which the pyrolysis was carried out (in ° C.).

### Example 2: Characterization of Prepared Nitrogen-Doped Carbon Nanosheets

The prepared nitrogen-doped carbon nanosheets were characterized by different material characterization techniques to gain insights into their physicochemical and surface properties. The physicochemical and surface characteristics of an adsorbent closely controls its ability to adsorb gases. As a result, the prepared nitrogen-doped carbon nanosheets were thoroughly evaluated by various methodologies to comprehend the effects of various preparation factors on surface characteristics and consequent carbon dioxide adsorption ability. Powder X-ray diffraction patterns were obtained using a Rigaku Miniflex-II diffractometer (manufactured by Rigaku, Japan) fitted with Cu-Kα anode (λ=0.15416 nm) within the range of 5 to 70° at a scan rate of 2°/min and a step size of 0.02°. Fourier-transform infrared (FTIR) scans in the range of 4000-650 cm⁻¹ were collected using Nicolet 6700 (Thermo Fisher Scientific, USA) for functional group identification. Scanning electron microscopy (SEM) micrographs were collected using a high-resolution field emission scanning electron microscope (FESEM) (TESCAN-LYRA-3, Czech Republic). The SEM samples were prepared by dispersing them in ethanol and then mounting them on a copper tape. Scanning electron microscopy/energy-dispersive X-ray (SEM-EDX) spectroscopy measurements were also carried out in the same instrument using an Oxford Aztec Energy X-MAX 50 EDS system. Raman spectra were collected in the range of 800-2000 cm⁻¹ using an iHR320 HORIBA Raman spectrometer (Horiba, Japan). Information about the surface area and pore size distribution was obtained by carrying out N₂ adsorption measurements at −196.15° C. in a Quadrasorb SI (Quantachrome Instruments, US). For the sample preparation and pre-treatment, 100-200 mg of the sample were degassed at 130° C. for 24 hours under a high dynamic vacuum (10⁻⁵ bar).

### Example 3: Carbon Dioxide and Nitrogen Isotherm Measurements

The potential of the prepared nitrogen-doped carbon nanosheets to adsorb and separate carbon dioxide from nitrogen was evaluated by measuring single component isotherms of nitrogen and carbon dioxide at temperatures of 0° C. and 25° C. within a pressure range of about 0 to 1 bar in a Quadrasorb SI (Quantachrome Instruments, US). Approximately 200 mg of the samples were pre-treated at 130° C. under vacuum for 24 hours before being weighed again. This was followed by an additional 2 hours of in situ degassing at 70° C. for 2 hours under a dynamic vacuum. Target temperatures for isotherm measurements were maintained using a water circulation bath containing a 1:1 mixture of water and ethylene glycol. The experimental data points were fitted with Langmuir and Dual Site Langmuir models to gain insights into the mechanism of adsorption [Hanif et al., Chemical Engineering Journal, 236, 91-99, 2014; Hanif et al., Industrial & Engineering Chemistry Research, 55, 8070-8078, 2016, both of which are incorporated herein by references in their entireties]. From the isotherm adsorption capacities, determinants of adsorbent performance were calculated using equations 1 to 4.

$${CO}_{2} working capacity ( mmol / g ) , {W}_{CO 2} = {n}_{CO 2}^{ads} - {n}_{CO 2}^{des} \qquad ( 1 )$$

$$Regenerability ( \% ) , R = ( \frac{{W}_{CO 2}}{{n}_{CO 2}^{ads}} ) \times 100 \qquad ( 2 )$$

$$Selectivity , {a}_{CO 2 / N 2} = ( \frac{{n}_{CO 2}^{ads}}{{n}_{N 2}^{ads}} ) ( \frac{{p}_{N 2}}{{p}_{CO 2}} ) \qquad ( 3 )$$

$$Sorbent Selection Parameter ( S ) = ( {( {α}_{CO 2 / N 2}^{ads} )}^{2} / ( {α}_{CO 2 / N 2}^{des} ) ) * ( {W}_{CO 2} / {W}_{N 2} ) \qquad ( 4 )$$

where n_{CO2}^{ads} (mmol/g) stands for carbon dioxide capacity obtained in the adsorption isotherm, n_{CO2}^{des} is the capacity obtained from the desorption isotherm, p_{N2} and p_{CO2} are the partial pressure of nitrogen and carbon dioxide, respectively.

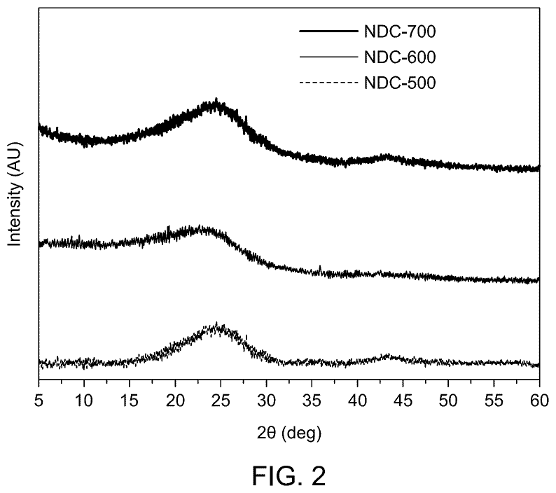

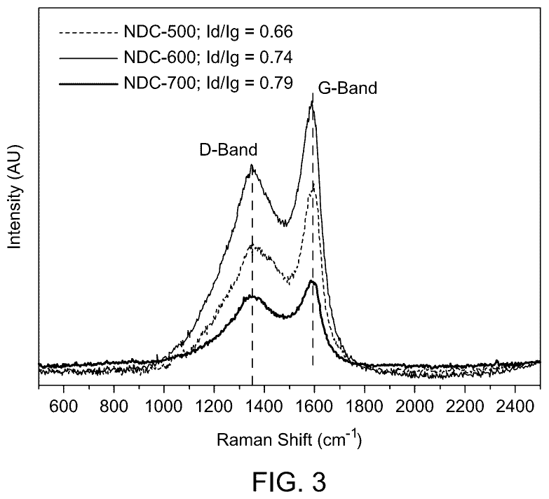

Referring now to FIG. 2, XRD diffractograms of the NDCs is depicted. Poor crystalline solid and low degree of graphitization is indicated by a large hump at approximately 2θ=25°. It may be concluded that these materials are vastly amorphous because all samples exhibit comparable XRD results without any clearly defined peaks. Referring now to FIG. 3, Raman spectra indicate the disordered nature of the prepared nitrogen-doped carbon nanosheets. Two bands at 1580 cm⁻¹ and 1350 cm⁻¹ in the Raman spectra are referred to as a D-band and a G-band, respectively. The G-band is representative of the E_{2g} vibrational mode of an sp² C—C bond in-plane stretching and is indicative of carbon's graphitic nature. The D-band signifies a peak of disorder with A_{Ig} vibrational mode, indicating defects in the graphitic lattice. The intensity ratio of D-band and G-band (I_{d}/I_{g} ratio) determined by Raman spectra. The prepared nitrogen-doped carbon nanosheets with a higher I_{d}/I_{g} ratio indicate a higher defect intensity and an I_{d}/I_{g} ratio approaching zero indicates a predominantly ordered graphitic structure. As indicated by the I_{d}/I_{g} ratios, NDC materials show disorder which increases with the increase of pyrolysis temperature.

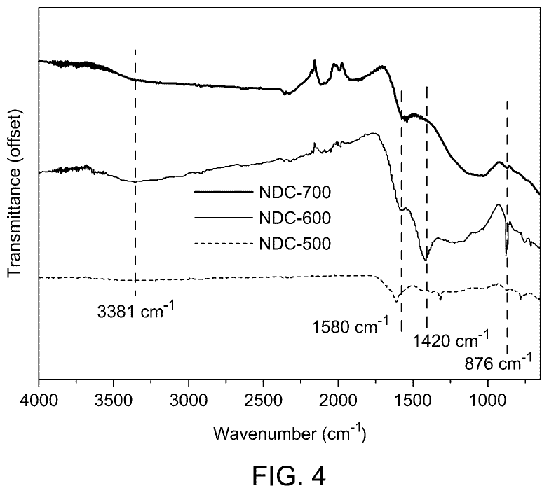

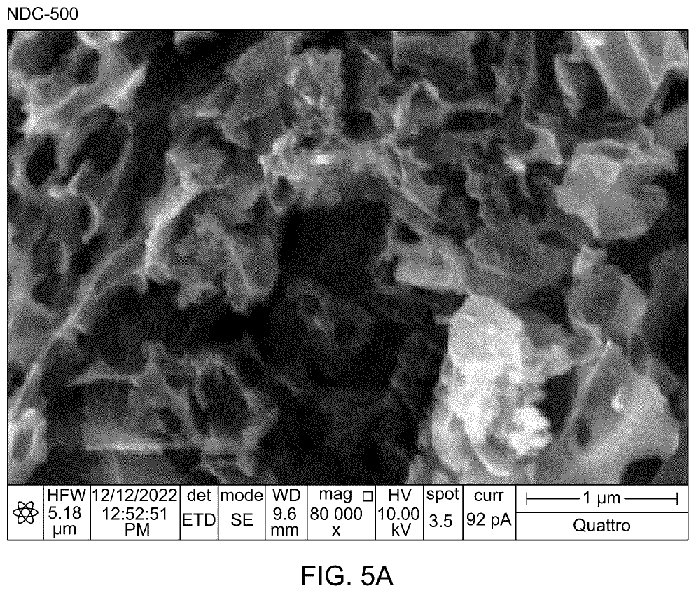

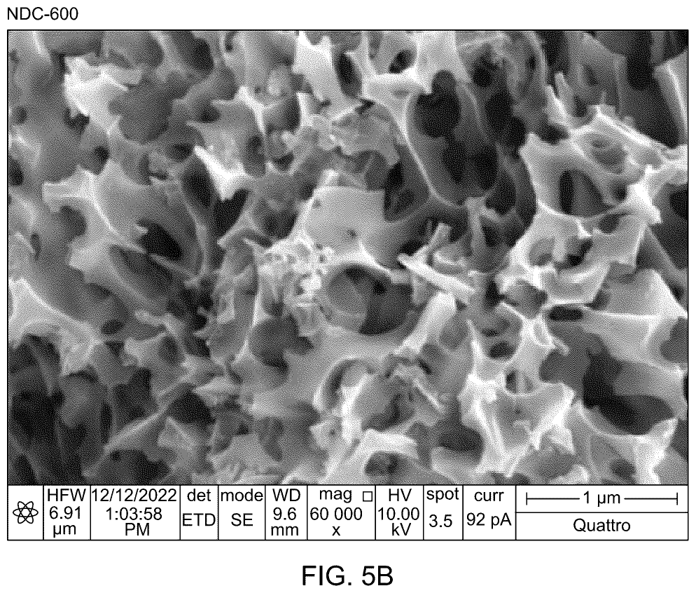

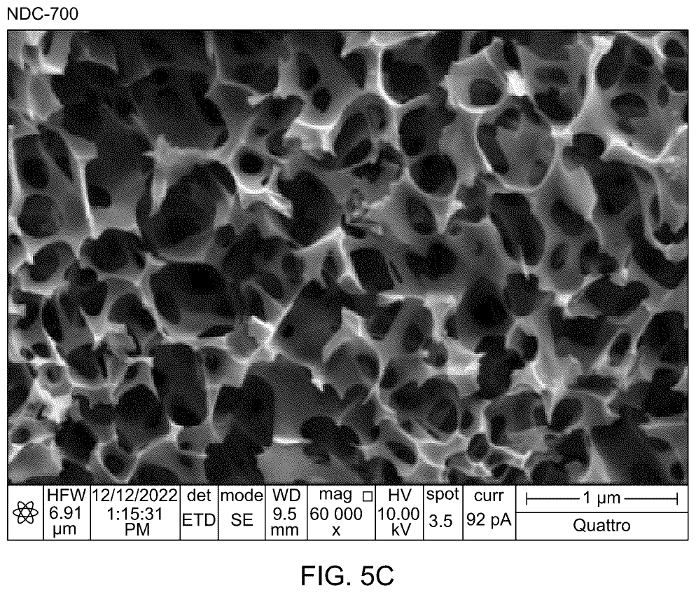

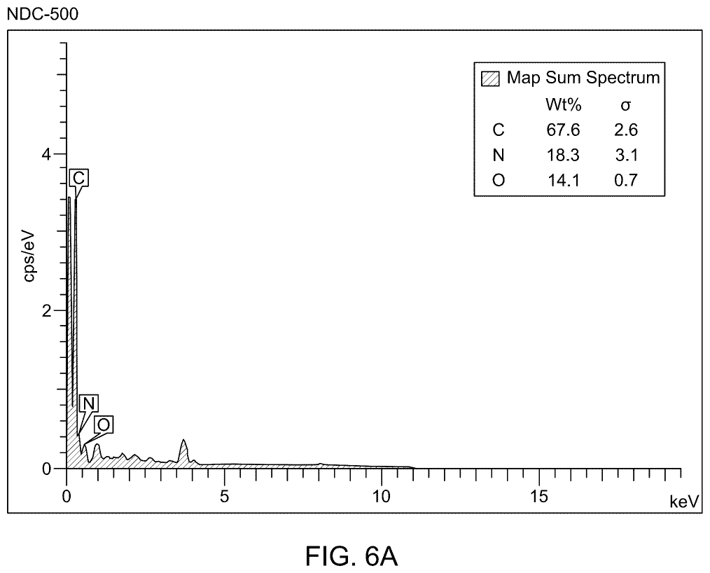

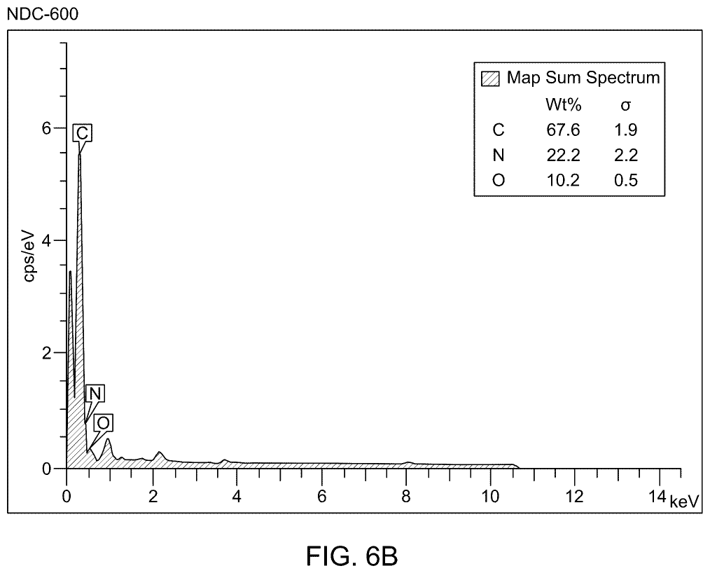

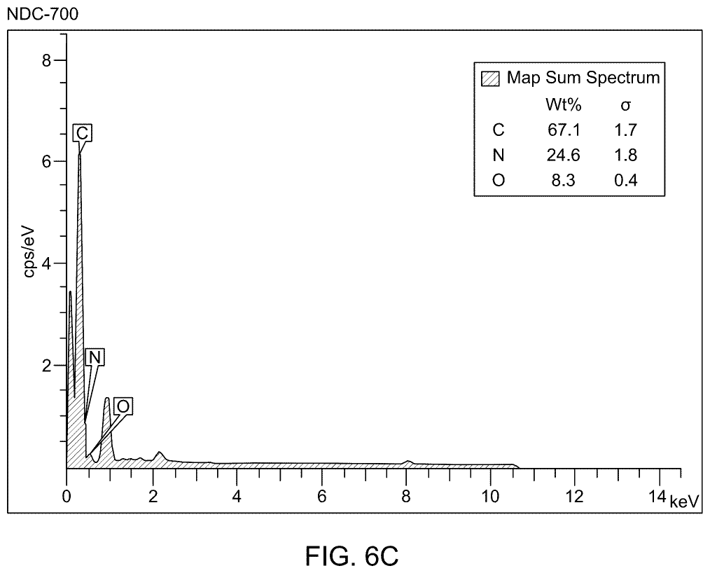

FTIR spectroscopy scans of the prepared nitrogen-doped carbon nanosheets were collected to examine the impact of pyrolysis temperature on the surface functionalization of the carbons. Referring now to FIG. 4, a broad peak around 3381 cm⁻¹ attributed to an —OH stretch, whereas peaks centered around 1580 cm⁻¹ are indicative of —C≡C— stretches of aromatic rings or —NH deformation. The peak around 1420 cm⁻¹ indicates a —CO stretch. Minor peaks around 876 cm⁻¹ are attributed to surface-CH groups. Referring now to FIGS. 5A, 5B, and 5C, FESEM micrographs of the prepared nitrogen-doped carbon nanosheets NDC-500, NDC-600, and NDC-700 showed a porous foam-type morphology formed of intricate interconnected network of perforated nanosheets. At higher pyrolysis temperatures, pore morphology is clearly visible, possibly due to complete pyrolysis of the precursor. Referring now to FIGS. 6A to 6C, EDX spectra of NDC-500, NDC-600, and NDC-700 show the presence of about 18 to 24% by weight of nitrogen in the prepared nitrogen-doped carbon nanosheets, confirming successful doping of the nitrogen heteroatom.

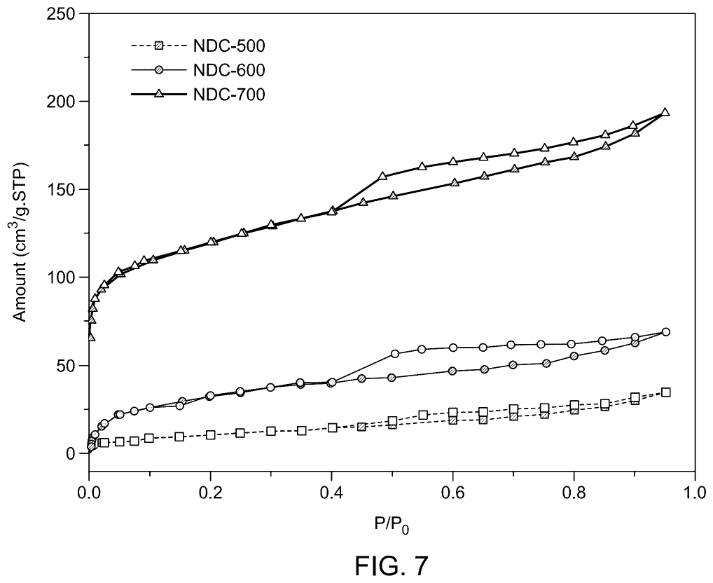

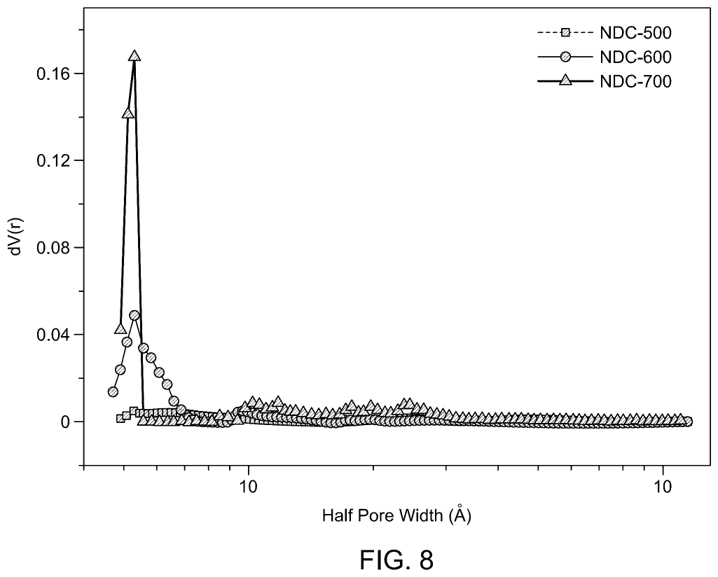

The pyrolysis temperature is known to impact surface area and pore characteristics of prepared adsorbents which, in turn, contributes to gas uptake. To measure surface and porosity characteristics of the prepared nitrogen-doped carbon nanosheets, nitrogen adsorption isotherms were measured at liquid nitrogen temperature (−196.15° C.) in a Quadrasorb SI (Quantachrome Instruments, US). Referring now to FIG. 7, pseudo type II isotherms of the prepared nitrogen-doped carbon nanosheets with narrow H3 hysteresis loop are observed, which is indicative of both microporosity and mesoporosity in the samples. Different amounts of nitrogen adsorption indicate varying surface areas of the prepared nitrogen-doped carbon nanosheets in order of NDC-700>NDC-600>NDC-500. Referring now to FIG. 8, a plot of density functional theory (DFT) pore size distribution reveals a predominance of microporosity, as well as some mesoporosity. NDC-700 has a narrow micropore size distribution centered around 5 Å, whereas NDC-500 and NDC-600 have a relatively broad pore size distribution.

Referring now to Table 1, which display Brunauer-Emmett-Teller (BET) surface areas and porosity measurements acquired from nitrogen adsorption at −196.15° C. The NDC-700 has the maximum surface area, total pore volume, and micropore volume, followed by NDC-600 and NDC-500. The average pore diameter demonstrates an inverse trend, indicating that it decreases from NDC-500 to NDC-600 to NDC-700. This suggests that all other parameters being held constant, a greater pyrolysis temperature results in a high surface area and a higher proportion of micropores, both of which are known to promote carbon dioxide adsorption on the carbons.

TABLE 1
Surface area and porosity characteristics of the
prepared nitrogen-doped carbon nanosheets.

| | S_{BET} | Vₜₒₜ | Vₘᵢ | %ₘᵢ | Dₐᵥ |
|---|---|---|---|---|---|
| Sample Code | (m²/g) | (cm³/g) | (cm³/g) | (%) | (nm) |
| NDC-500 | 38.72 | 0.046 | 0.024 | 52.17 | 2.40 |
| NDC-600 | 118.30 | 0.097 | 0.045 | 46.39 | 1.60 |
| NDC-700 | 426.20 | 0.280 | 0.177 | 63.21 | 1.32 |

S_{BET} = BET surface area, Vₜₒₜ = total pore volume calculated at P/Pₒ 0.95, Vₘᵢ = Horvath-Kawazoe micropore volume, %ₘᵢ = (Vₘᵢ/Vₜₒₜ)*100, Dₐᵥ = average pore diameter

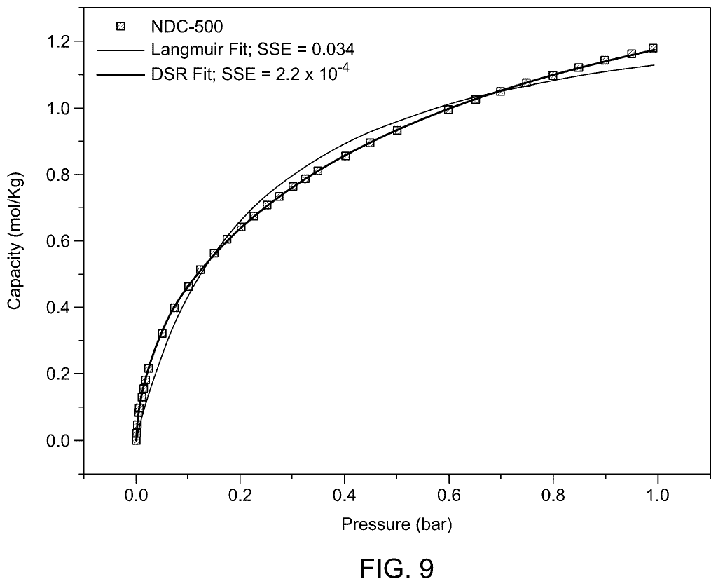

Referring now to FIG. 9, the isotherm model fitting of experimental data revealed that the dual-site Langmuir (DSL) model provides a better fit than the Langmuir model as indicated by a lower sum squared errors fitness parameter than the Langmuir fit. This can be indicative of two different types of adsorption sites having varying interactions with adsorbate molecules. Subsequently, all other isotherms were fitted with DSL model.

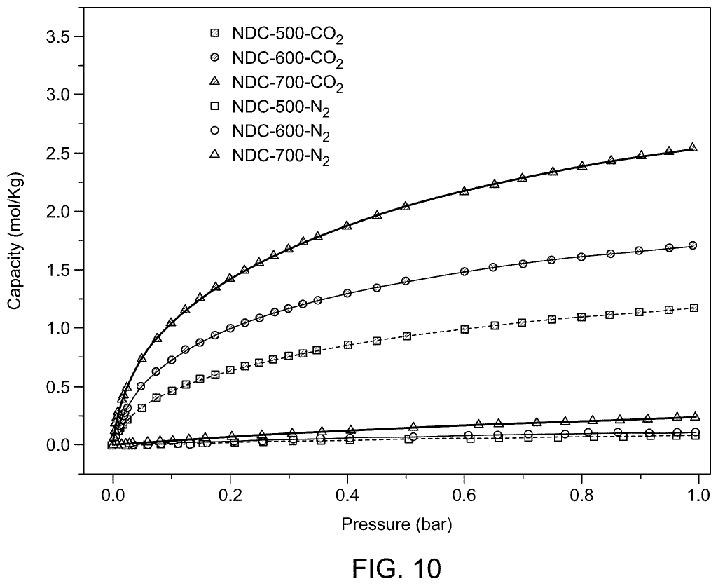

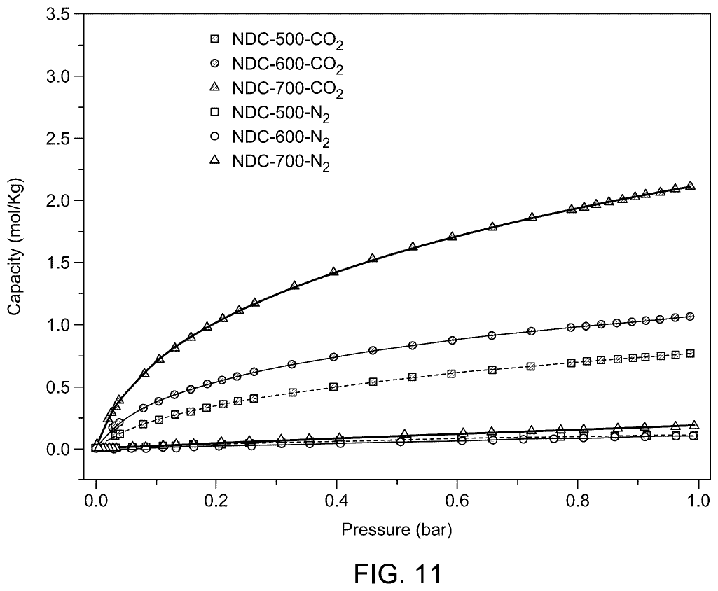

Referring now to FIGS. 10 and 11, carbon dioxide adsorption capacity at 1 bar ranged from about 0.76 to 2.53 mol/kg across the measurement temperature. NDC-700 has the highest carbon dioxide adsorption capacity, followed by NDC-600. NDC-500 has the lowest capacity among the three samples for both studied temperatures of 0 and 25° C. For the same adsorbent, capacity at 0° C. is higher than that at 25° C. These trends show a positive correlation with surface area and pore volumes of nitrogen-doped carbon nanosheets. However, despite having a lower surface area compared to other reported carbon-based adsorbents, these materials exhibit carbon dioxide uptake, which can be attributed to the presence of the nitrogen heteroatom that adds to the alkalinity of the adsorbents. Likewise, tailored narrow micropores with a diameter of less than 1 nm facilitate better interaction between carbon dioxide and the adsorbent. Additionally, carbon dioxide capacity could possibly be enhanced by hydroxyl and aromatic functional groups through acid-base and π-π interactions, respectively.

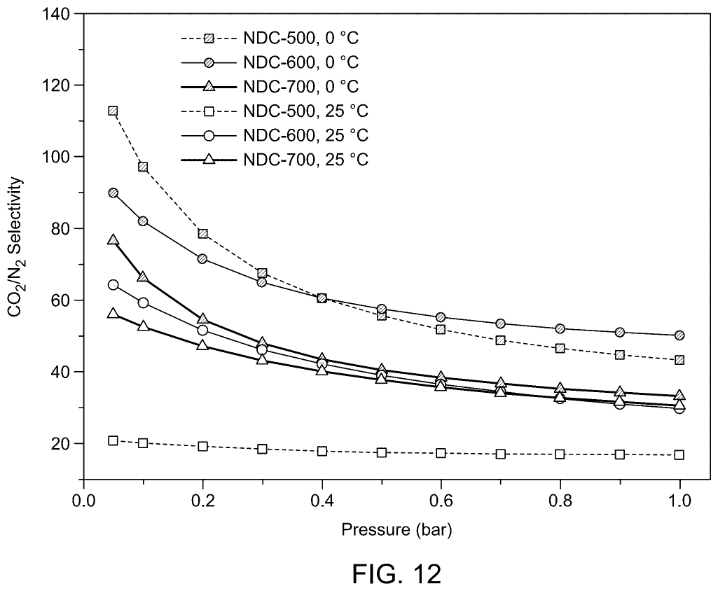

Referring now to FIG. 12, carbon dioxide over nitrogen selectivity for a post-combustion capture representative mixture (15% CO₂ and 85% N₂) was plotted. The adsorbent's selectivity's ranged from 17 to 112 across studied pressures and temperatures, highlighting their potential for CO₂—N₂ separation. Further, selectivity at 0° C. is higher than at 25° C. for all the adsorbents.

The Vacuum Swing Adsorption (VSA) process is a well-established cyclic process used in various gas separation processes, providing energy-efficient gas separation with automatic control. However, it may not be feasible to use large quantities of adsorbent in VSA when evaluating adsorbents at lab-scale. Isotherms can instead provide a reasonable indication of the suitability of adsorbent for a full-scale VSA process. Some of the indicators of VSA performance from the isotherm results are shown in Table 2. For example, actual usable capacity in the VSA process is called working capacity, with a higher working capacity being preferred. NDC-700 showed higher working capacity among all adsorbents at both 0° C. and 25° C. However, working capacity is not a sole indicator of VSA performance as, despite better working capacity, lower carbon dioxide over nitrogen selectivity may limit its application. NDC-600 has the best selectivity at 1 bar and 0° C. and almost the same selectivity as that of NDC-700 at 25° C. which, in turn, is higher than that of NDC-500. Therefore, considering selectivity, NDC-600 may be regarded as the best adsorbent. Regenerability is yet another factor to be taken into consideration while deciding suitability of adsorbents for VSA processes as it indicates ability of adsorbent to be reused in cyclic experiments. All adsorbents exhibit a good regenerability of about 60 to 70%. Since there cannot be a single indicator to decide suitability of adsorbent for VSA process, a unified parameter called sorbent selection parameter(S) was devised, which considers working capacity, selectivity, and regenerability to provide a single empirical value for comparison. Higher S values indicate greater suitability for a particular VSA process under given conditions. Despite its lower working capacity, NDC-600 is the best choice for VSA at 0° C. and NDC-700 performs well at 25° C. Results are shown in Table 2.

TABLE 2
CO₂—N₂ separation performance indicators for
VSA process operation between 1 bar and 0.1 bar.

| | | CO₂ Working | | | Sorbent |
|---|---|---|---|---|---|
| Sample | Temperature | Capacity (W) | Selectivity | | Selection |
| Code | (° C.) | (mmol/g) | α_{CO2/N2} | Regenerability | Parameter (S) |
| NDC-500 | 0 | 0.71 | 43 | 61 | 193 |
| NDC-600 | 0 | 0.98 | 50 | 58 | 331 |
| NDC-700 | 0 | 1.50 | 33 | 60 | 130 |
| NDC-500 | 25 | 0.53 | 17 | 66 | 85 |
| NDC-600 | 25 | 0.73 | 30 | 69 | 123 |
| NDC-700 | 25 | 1.39 | 31 | 66 | 160 |

In the present disclosure, high-performance nitrogen-doped carbon nanosheets were derived by single-step pyrolysis activation of Albizia procera leaves containing a high percentage of nitrogen. By the careful choice of a nitrogen-rich precursor, an activation agent, and a pyrolysis temperature, a narrow micropore size distribution along with a high percentage of nitrogen doping was obtained. Structurally, NDCs showed a high percentage of nitrogen doping, hydroxyl groups, and aromatic rings, which lead to a high carbon dioxide capacity and good carbon dioxide over nitrogen selectivity. NDC-700 exhibited the highest carbon dioxide adsorption (2.54 mmol/g) and working capacity (1.50 mmol/g) at 0° C. but a lower CO₂/N₂ selectivity (33) than NDC-600 and NDC-500 which showed selectivity's of 50 and 43, respectively. For an overall comparison, a sorbent selection parameter(S) was calculated by taking into consideration working capacity, regenerability, and selectivity of the adsorbents. Based on sorbent selection parameters, NDC-600 is thought to show the best CO₂/N₂ separation performance at 0° C., whereas NDC-700 performed better at 25° C. for CO₂—N₂ VSA. By adjusting pyrolysis conditions, activation potentials of carbon dioxide and steam (H₂O) was utilized during the carbonization step itself without a need of external supply of these gases for longer periods.

Numerous modifications and variations of the present disclosure are possible in light of the above teachings. It is, therefore, to be understood that within the scope of the appended claims, the disclosure may be practiced otherwise than as specifically described herein.

1. A method of preparing nitrogen-doped carbon nanosheets, comprising:
mixing dried and pulverized Albizia procera with an activation agent in a mass ratio from 1:1 to 1:5 to form a mixture,
wherein the activation agent is a carbonate salt, and
heating the mixture in an inert atmosphere at a temperature in the range of 400 to 800° C. for 2 to 8 hours to form the nitrogen-doped carbon nanosheets;
wherein the nitrogen-doped carbon nanosheets have an average pore diameter of 0.5 to 2.5 nm and a carbon dioxide adsorption capacity of 1.0 mmol/g to 3.50 mmol/g.

2. The method of claim 1, wherein the mass ratio of Albizia procera to activation agent is 1:2, the heating temperature is 700° C., the heating time is 5 hours, and the nitrogen-doped carbon nanosheets have an average pore diameter of 1.2 to 1.5 nm.

3. The method of claim 1, wherein the nitrogen-doped carbon nanosheets have a porous foam shape comprising interconnected networks of perforated nanosheets.

4. The method of claim 1, wherein the nitrogen-doped carbon nanosheets comprise nitrogen in an amount from 15 to 30% by weight based on a total weight of the nitrogen-doped carbon nanosheets.

5. The method of claim 1, wherein the nitrogen-doped carbon nanosheets comprise carbon in an amount from 65 to 70% by weight and oxygen in an amount from 5 to 20% by weight based on the total weight of the nitrogen-doped carbon nanosheets.

6. The method of claim 1, wherein the nitrogen-doped carbon nanosheets have a Brunauer-Emmett-Teller surface area of 25 to 450 m²/g.

7. The method of claim 1, wherein the mass ratio of Albizia procera to activation agent is 1:2, the heating temperature is 700° C., the heating time is 5 hours, and the nitrogen-doped carbon nanosheets have a Brunauer-Emmett-Teller surface area of 410 to 440 m²/g.

8. The method of claim 1, wherein the nitrogen-doped carbon nanosheets have a total pore volume of 0.030 to 0.300 cm³/g.

9. The method of claim 1, wherein the mass ratio of Albizia procera to activation agent is 1:2, the heating temperature is 700° C., the heating time is 5 hours, and the nitrogen-doped carbon nanosheets have a total pore volume of 0.150 to 0.200 cm³/g.

10. The method of claim 1, wherein the nitrogen-doped carbon nanosheets have a Horvath-Kawazoe micropore volume of 0.010 to 0.200 cm³/g.

11. The method of claim 7, wherein 40 to 70% of pores in the nitrogen-doped carbon nanosheets are micropores based on the total pore volume.

12. The method of claim 1, wherein the mass ratio of Albizia procera to activation agent is 1:2, the heating temperature is 700° C., the heating time is 5 hours, and the nitrogen-doped carbon nanosheets have a carbon dioxide adsorption capacity of 2.4 to 2.8 mol/kg at a temperature of 0° C. and at a pressure of 1 bar.

13. The method of claim 1, wherein the nitrogen-doped carbon nanosheets have a nitrogen adsorption capacity of 0.01 to 0.20 mol/kg at a temperature in the range of 0 to 25° C. and at a pressure of 1 bar.

14. The method of claim 1, wherein the nitrogen-doped carbon nanosheets have a carbon dioxide working capacity of 0.5 to 2 mmol/g.

15. The method of claim 1, wherein the mass ratio of Albizia procera to activation agent is 1:2, the heating temperature is 700° C., the heating time is 5 hours, and the nitrogen-doped carbon nanosheets have a carbon dioxide working capacity of 1.3 to 1.7 mol/kg at a temperature of 0° C. and at a pressure of 1 bar.

16. The method of claim 1, wherein the mass ratio of Albizia procera to activation agent is 1:2, the heating temperature is 600° C., the heating time is 5 hours, and the nitrogen-doped carbon nanosheets have a selectivity of 47 to 52 based on a fraction of carbon dioxide adsorption capacity over nitrogen adsorption capacity multiplied by a fraction of nitrogen partial pressure over carbon dioxide partial pressure at a temperature of 0° C.

17. The method of claim 1, wherein the mass ratio of Albizia procera to activation agent is 1:2, the heating temperature is 700° C., the heating time is 5 hours, and the nitrogen-doped carbon nanosheets have a selectivity of 28 to 33 based on the fraction of carbon dioxide adsorption capacity over nitrogen adsorption capacity multiplied by the fraction of nitrogen partial pressure over carbon dioxide partial pressure at a temperature of 25° C.

18. The method of claim 1, wherein the mass ratio of Albizia procera to activation agent is 1:2, the heating temperature is 500° C., the heating time is 5 hours, and the nitrogen-doped carbon nanosheets have a regenerability of 59 to 63% based on the carbon dioxide working capacity and carbon dioxide adsorption capacity at a temperature of 0° C.

19. The method of claim 1, wherein the mass ratio of Albizia procera to activation agent is 1:2, the heating temperature is 600° C., the heating time is 5 hours, and the nitrogen-doped carbon nanosheets have a regenerability of 67 to 72% based on the carbon dioxide working capacity and carbon dioxide adsorption capacity at a temperature of 25° C.

20. The method of claim 1, wherein the carbonate salt is sodium bicarbonate.
